(19) United States
(12) Patent Application Publication
(10) Pub. No.: US 2007/0187501 A1
(43) Pub. Date: Aug. 16, 2007

(54) Method of and apparatus for treating defective labels, in particular rfid label printer

(76) Inventors: Johannes Lenkl, Freising (DE); Eugene Korzenjewski, Clinton, SC (US)

Correspondence Address: Jonathan A Platt;Renner Otton Boissell & Sklar, 19th Floor, 1621 Euclid Avenue, Cleveland, OH, 44115, US

(21) Appl. No.: 11/587,190

(22) PCT Filed: Apr. 19, 2005
(86) PCT No.: PCT/EP05/04181

§ 371 Date: Oct. 20, 2006

(30) Foreign Application Priority Data
Apr. 20, 2004 (DE) 10 2004 019 073.9

(51) Int. Cl. G06K 7/08; G06F 15/12; G06K 7/00

(52) U.S. Cl. 235/451; 235/438; 235/432

(57) ABSTRACT

The invention concerns a method of treating defective labels (E′), in particular RFID labels, in a label printer, and the label printer itself, in which the labels (E, E′) are arranged on a label carrier strip (ET) in succession in the conveyor direction of the label carrier strip (ET), which is fed under tensile stress at least to a first writing unit (22) for the selective transfer of items of information onto the labels (E) and then to a dispensing unit (24) in which the labels (E) are individually removed from the label carrier strip (ET) and delivered in a dispensing operation onto an article to be provided with a label (E), wherein after the dispensing operation the empty label carrier strip (ET) is received in an empty material storage unit (32). The label carrier strip (ET) with the labels (E, E′) arranged thereon is fed to a testing unit (14) which is arranged upstream of the dispensing unit (24) in the conveyor direction of the label carrier strip (ET) and which checks the individual labels (E, E′) for defects, and in the case of a defective label (E′) the dispensing operation for the label (E′) onto an article to be provided with a label (E) does not occur.

The present invention concerns a method of treating defective labels, in particular RFID labels, in a label printer, as set forth in the classifying portion of claim 1, and a label printer for printing labels in particular for carrying out a method of treating defective labels, preferably RFID labels, as set forth in the classifying portion of claim 20.

Labels are being used nowadays for the most widely varying purposes. Thus labels are arranged on products for example as information carriers in respect of goods for consumers, but they can also be applied as transport information and/or stocktaking information carriers to goods or parcels of goods to be dispatched or delivered. In practice labels are known for that purpose, which can be printed with the respectively desired items of information by means of a label printer. In that respect the items of information can be printed on the label in accordance with a respective corresponding requirement, both in clear text, that is to say in a form which can also be read directly by a customer, recipient and so forth, and also in the form of bar codes and so forth.

In addition in practice labels are known which are provided with electronic memory means in which the respective items of information can be temporarily or constantly written by means of radio waves and/or read out again. Labels of that kind are usually referred to as RFID labels. They involve electronic memory means which are disposed in a label carrier such as for example a conventional paper label and can be written to and/or read out by means of radio signals. In that respect different frequency bands are used, such as the HF band (6 MHz to 30 MHz), the UHF band (30 MHz to 300 MHz) or the UHF band (300 MHz to 3,000 MHz).

In practice those previously known labels, whether they involved conventional printable labels, RFID labels or combinations thereof, were in any case printed upon or written to and/or read out and then discharged from the printing or writing unit and/or reading unit in order to be applied to the respective article to be identified. If the label was already damaged at the time of printing or writing thereto and/or possibly reading, then the label was identified as such, for example by printing on a black bar. An operator then removed the label from the label carrier strip manually. In the latter case, a damaged label meant that the information disposed on it or in it could not be correctly read upon further handling of the article identified in that way, and that therefore also involved incorrect control or incorrect stocktaking or non-purchase of the article identified in that way.

The object of the present invention is to provide a method of treating defective labels, in particular RFID labels, and a label printer of the kind set forth in the opening part of this specification, which reliably make it possible to prevent identification of an article provided with a label, in the case of a defective label.

In terms of the method the foregoing object is attained by the features of claim 1. Following claims 2 to 19 set forth advantageous configurations in respect thereof.

By virtue of the label carrier strip on which the labels are arranged in succession in the conveyor direction thereof being fed to a testing unit which is arranged upstream of the dispensing unit and in particular upstream of the at least one of the plurality of writing and/or reading units, a defective label can be recognised by the testing operation performed by the testing unit, and it is possible in that way to prevent the defective label being dispensed to the article to be identified or applied there. In accordance with the invention the operation of dispensing a label of that kind onto the article is suppressed and, as is described in greater detail hereinafter, the defective label is disposed of elsewhere.

It is to be noted that the label can be a printable label, a pure RFID label or a label representing a combination of a printable label and an RFID label. If the label involves an RFID label, it is possible to use all frequency bands which are employed for RFID labels. The frequencies or frequency ranges of the HF, VHF or UHF range are preferred, preferably 6 MHz to 30 MHz, in particular 13.56 MHz, 30 MHz to 300 MHz, 300 MHz to 3,000 MHz, but also 125 KHz to 135 KHz and 3 GHz to 30 GHz, in particular 2.45 GHz.

In addition it is to be noted that, in the case of an only printable label, the first writing unit can be a writing printing unit, for example in the form of a thermotransfer printing unit, in the case of a pure RFID label it can be an RFID writing and/or reading unit and, in the case of a combined label, that is to say a printable label with an RFID portion, it can be a writing printing unit or an RFID writing and/or reading unit. It will be appreciated that it is also possible to provide a plurality of writing units or a combination of writing and reading units, in which respect those units can be selectively the above-mentioned units.

It is further to be noted that the arrangement of the labels on the label carrier strip can be such as to observe equal or unequal spacings or in immediately mutually adjoining relationship. There is also the possibility of the labels being of a width, that is to say an extent transversely with respect to the conveyor direction of the label carrier strip, which is less than the width of the label carrier strip. It will be appreciated however that the labels can also be of the same width as the label carrier strip. Furthermore the labels can be held on the label carrier strip by means of an adhesive layer which is at least partially applied at the side facing towards the label carrier strip, in which case, on its side facing towards the label, the label carrier strip is provided with a coating which allows the label with its adhesive layer to adhere on the label carrier strip but which also permits detachment of the label from the label carrier strip without destroying the adhesive layer. Finally, the label carrier strip and the label disposed thereon can also be entirely or partially covered by a cover layer which, in the case of printable labels, after the printing operation, can be applied to the combination of label carrier strip and label, in the case of pure RFID labels it can be applied prior to or after the reading and/or writing operation and, in the case of a combination of RFID label and printable label, after the printing operation, it can be applied to the label. That cover layer serves in particular to protect the label on the article provided with the label, in particular in relation to prohibited detachment of the label from the article and/or the ingress of moisture.

It is preferable for the present invention that the label has at least one printable portion or a print carrier portion as well as an RFID portion, the testing unit checking at least the RFID portion for defects. In that case the RFID portion and the printable portion of the label can be arranged both in succession in the conveyor direction of the label carrier strip and also in mutually coincident relationship. In addition however the testing unit can also check the printable portion for defects, for example tears, colour flaws and so forth. For the RFID portion it is preferable for it to operate in a frequency range of 300 MHz to 3,000 MHz.

In order to ensure that the label is tested prior to a first working operation, that is to say for example the printing operation thereon, it is preferable if the testing unit is or becomes arranged upstream of the first writing unit in the label carrier strip conveyor direction. A particularly compact structure is achieved if the testing unit is formed by the RFID reading and/or writing unit used for the reading and/or writing operation on the RFID portion of the label. In other words, the testing unit is the RFID reading and/or writing unit so that a label printer which is designed in that way in accordance with the invention has two writing units, the first writing unit for applying a print to the printable portion of the label and as a second writing unit an RFID reading and/or writing unit for reading and/or writing on the RFID portion of the label. If the label is a pure RFID label which is not printed upon, then, as in the case of a combination consisting of an RFID label and a printable label, it is possible to use both a testing unit in the form of an RFID reading unit and also an RFID reading and/or writing unit. The writing unit for an only printable label or the printable portion of an RFID label with printable portion can then be for example a thermotransfer printing unit. If the label is a label which is only to be printed upon, the testing unit can be formed by a scanner, a CCD camera and so forth.

As has already been set forth hereinbefore, an essential aspect of the invention is that the label which is assessed by the testing unit as being defective is not discharged or dispensed onto the article to be identified by the label, but is disposed of elsewhere. A possibility in that respect is that the label recognised as being defective by the testing unit remains on the label carrier strip and is passed together with the label carrier strip into the empty material storage means.

Detachment of the label from the label carrier strip can be effected in quite different ways. One possible option in this respect provides that the respective label is detached manually from the label carrier strip. If the label detachment or dispensing operation is to be effected automatically, it is then possible to provide at the exit opening of the label printer a dispensing unit having a dispensing edge at which the label carrier strip is deflected through a small and preferably very small radius, in which case the label becomes detached from the label carrier strip. In order in such a situation to convey a defective label together with the label carrier strip into the empty material storage unit, it is possible to provide on the one hand that the tensile stress in the label carrier strip is reduced in such a way that the deflection radius of the label carrier strip at the dispensing edge is increased to such a degree that detachment of the label from the label carrier strip does not take place. On the other hand, the increase in the deflection radius can also be effected, with the tensile stress being at least approximately maintained, more specifically in such a way that the label carrier strip follows a larger deflection radius in the region of the dispensing edge. It is therefore advantageous if, in the case of a defective label, the tensile stress in the label carrier strip is so reduced that the deflection radius of the label carrier strip at the dispensing edge is greater than the radius of the dispensing edge so that detachment of the label from the label carrier strip does not take place at the dispensing unit or the dispensing edge. In this connection it is to be pointed out that the dispensing edge can involve a curved surface, even if only of a very small radius, and also can be of a configuration which involves only line contact with the label carrier strip.

Known label printing apparatuses or label printers have a conveyor unit which includes at least one first drive unit arranged upstream of the dispensing unit in the label carrier strip conveyor direction and at least one second drive unit arranged downstream of the dispensing unit, both of which are driven and apply a tensile stress to the label carrier strip. In order now to permit the label to be detached from the label carrier strip by a reduction in the tensile stress with a concomitant increase in the deflection radius of the label carrier strip at the dispensing edge, the drive power of the first and second drive units can be selected to be different. If the first and the second drive unit are formed by at least one drive roller, the difference in the drive power can be afforded by differing rotary speeds for the first and second drive units. In particular in that respect the rotary speed of the second drive roller can be selected to be less than the rotary speed of the first drive roller so that the first drive roller advances the label carrier strip faster than the second drive roller which then applies a braking effect to the label carrier strip, whereby a loop is formed in the label carrier strip at the dispensing edge, the radius of the loop being larger than the radius of the dispensing edge of the dispensing unit.

In addition, for reducing the tensile stress in the label carrier strip and thus to afford the enlarged deflection radius, there is the possibility of the second drive roller being stopped whereas the first drive roller continues to be driven. In other words, the first drive roller then further advances the label carrier strip whereas the second drive roller holds the label carrier strip fast so that a loop is formed in the label carrier strip in the region of the dispensing unit or the dispensing edge, the radius of the loop being larger than the radius of the dispensing edge.

A further possible way of affording the enlarged radius in the label carrier strip at the dispensing edge or the dispensing unit by a reduction in the tensile stress in the label carrier strip is for the first drive roller to be stopped and for the second drive roller to be driven in opposite relationship to the normal conveyor direction. In other words the second drive roller is operated in reverse so that the label carrier material which has already passed the dispensing edge in the conveyor direction is conveyed back in the direction of the dispensing unit or dispensing edge, whereby a loop is also formed in the label carrier strip, the radius thereof being larger than the radius of the dispensing edge. Then the next label which is defective can be taken past the dispensing edge along the larger deflection radius without that label being detached from the label carrier strip and dispensed.

A further possible way of preventing the defective label from being dispensed or applied to the article to be identified is that the deflection radius of the label carrier strip at the dispensing edge is increased in relation to the radius of the dispensing edge. That increase in the deflection radius, as already indicated hereinbefore, can be afforded by means of a reduction in the tensile stress in the label carrier strip. A further possibility involves achieving that increase in the deflection radius by an adjusting member. That can be for example a deflection roller of large radius, which is introduced into the conveyor path of the label carrier strip. That deflection roller is initially introduced into the conveyor path of the label carrier strip in such a way that it bears with its outside peripheral surface tangentially against the label carrier strip. Then it can be moved continuously in a direction transverse with respect to the wide direction of the label carrier strip, while virtually maintaining the tensile stress, whereby the deflection radius at the dispensing edge is increased continuously or step-wise.

An alternative configuration for the adjusting member can provide that the dispensing unit can be displaced into at least one first working position in which the dispensing operation is effected and at least one second working position in which the dispensing operation does not take place. In other words, the dispensing unit forms a routing arrangement, by means of which there is the option of dispensing an intact label and conveying a defective label together with the label carrier strip into the empty material storage unit. In this case the dispensing unit can be moved into the first or the second working position in dependence on the test result from the testing unit.

In order to permit the defective label together with the label carrier strip to be conveyed into the empty material storage unit in the second working position, it is advantageous if the dispensing edge of the dispensing unit is provided with at least one first curved functional surface which serves as a dispensing edge and at least one second curved functional surface, wherein the radius of curvature of the first functional surface is selected to be smaller than the radius of curvature of the second functional surface. As already indicated hereinbefore, the first curved functional surface can be of a radius of curvature of greater than zero or a radius of curvature equal to zero, in which latter case the curved functional surface is in the form of a dispensing edge in the narrower sense, which involves only line contact with the label carrier strip.

A further possible way of preventing discharge of a defective label to an article to be identified provides that the defective label is dispensed onto a collecting unit for defective labels. In other words the defective label is admittedly dispensed but not onto the article to be identified therewith, but rather onto a collecting unit which is specifically provided for that purpose.

In this respect the collecting unit can be of differing configurations. For example the collecting unit can be a plate extending in parallel relationship with the direction of movement of the label to be dispensed or a plate-shaped element onto which the defective label is dispensed. So that the dispensing operation is not hindered by that collecting unit when dealing with intact labels, it can further be provided that the collecting unit can be moved and in particular pivoted into the dispensing path of a label to be dispensed and out again. In order in that case to be able to accommodate a plurality of defective labels in succession, it is further advantageous if the collecting unit is displaced in a preferably vertical direction to receive a plurality of defective labels. If for example the label is oriented with its two flat sides horizontal and thus the dispensing path is also oriented at least approximately horizontally, then the plate-shaped element of the collecting unit is also oriented horizontally. In that case it is then advantageous if the collecting unit is displaceable vertically.

A further possible form for the collecting unit comprises a roller which is disposed in the label carrier strip conveyor direction upstream of the dispensing unit outside or possibly also within the printer housing and which is drivable continuously or discontinuously to receive a plurality of defective labels. In order to prevent a defective label dropping off that roller, it can further be provided that the roller can be provided with an adhesive coating once or a plurality of times in succession. The latter can be effected for example by the roller, as it rotates, moving past a unit which applies an adhesive layer and which also applies the adhesive to labels already disposed on the roller.

In regard to the apparatus the foregoing object is attained by claim 20. Following appendant claims 21 to 37 set forth advantageous configurations in respect thereof. In connection with the apparatus it is to be noted that the same alternative configurations and embodiments as set forth hereinbefore in relation to the method according to the invention apply in respect of the apparatus and the advantages linked thereto are also applicable. Therefore hereinafter only supplemental aspects will be discussed.

In principle there is the possibility of the individual procedures involved in the method according to the invention and the label printer according to the invention being controlled in analog fashion. It is however preferable to provide an electronic control unit which possibly has a CPU which is freely programmable. In that case the testing unit or the RFID reading and/or writing unit and/or writing printing unit and/or the dispensing unit and/or the conveyor unit can then be connected to the control unit. Particularly in the case of a dispensing unit having a dispensing edge which has a first and a second working position, the control unit can control the respective working position of the dispensing edge in dependence on the test result of the testing unit which is passed from the testing unit to the control unit. The control unit can then also control the collecting unit for defective labels. Furthermore the control unit can also control the conveyor device, that is to say in particular the different drive powers at the drive rollers, in dependence on the test result. Finally the control unit can also control lifting of the writing printing unit, which is advantageous in the case of pure RFID labels or RFID labels with a printable portion, in particular to protect the writing printing unit which for example can involve a thermotransfer printing unit.

Further advantageous configurations and various embodiments by way of example of the present invention are described hereinafter with reference to the accompanying drawings. It is to be noted in this respect that the terms “left”, “right”, “bottom” and “top” used in the description of the embodiments by way of example relate to the Figures with the Figure identifications and references being normally readable. More specifically in the drawing:

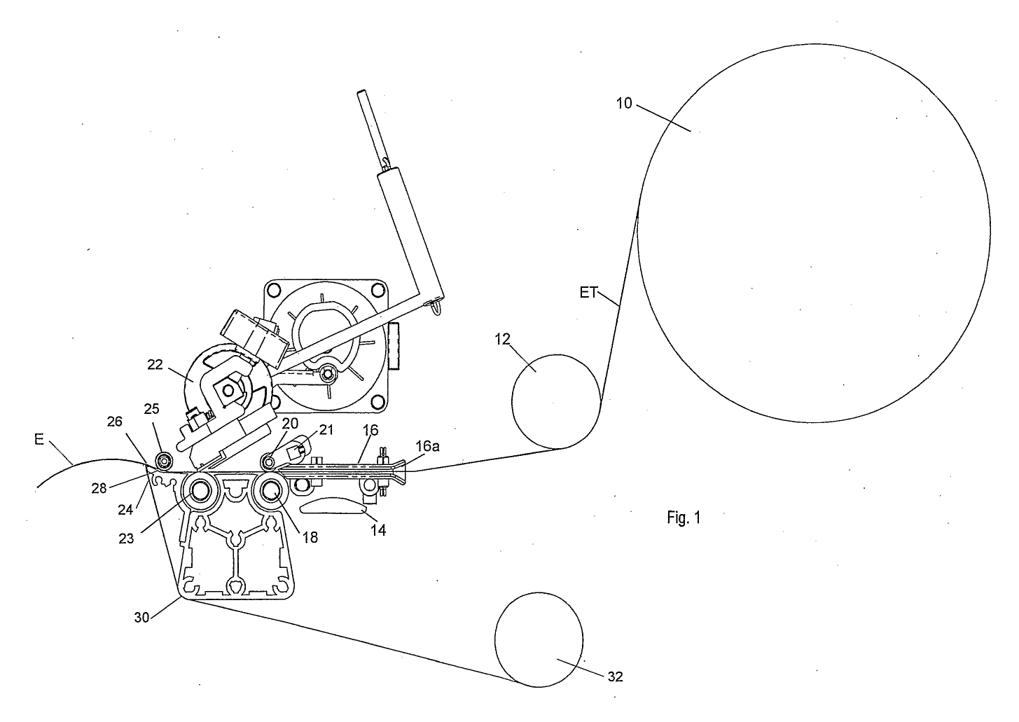

FIG. 1 shows a diagrammatic side view of a label printer according to the invention at the moment of delivery of an intact label to an article to be identified by the label,

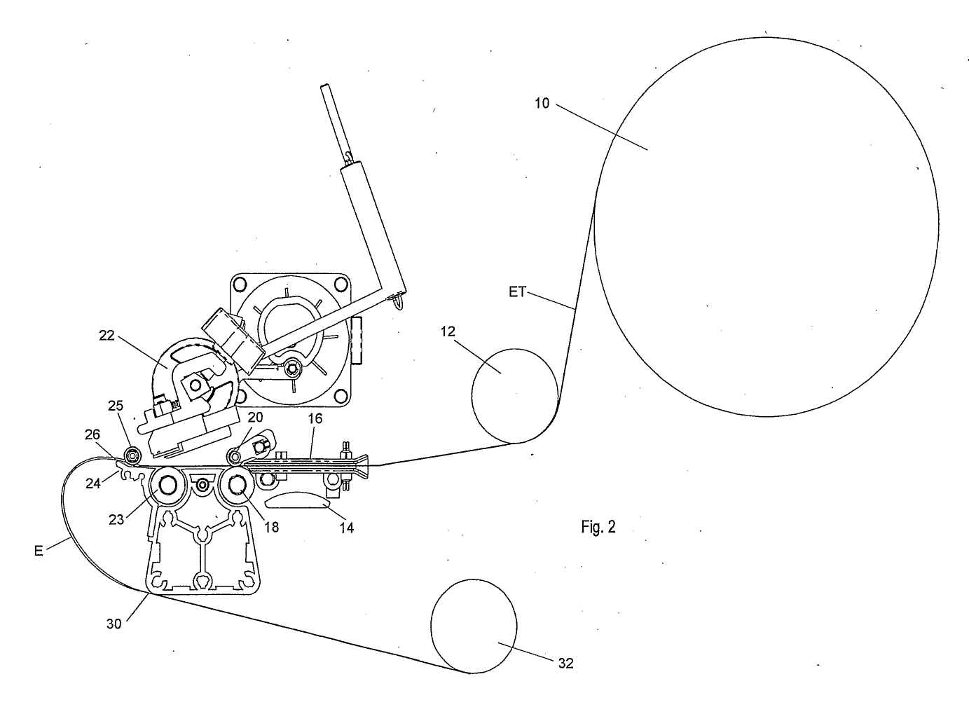

FIG. 2 shows a diagrammatic side view similar to FIG. 1 at the moment of deflection of the label carrier material strip with a defective label,

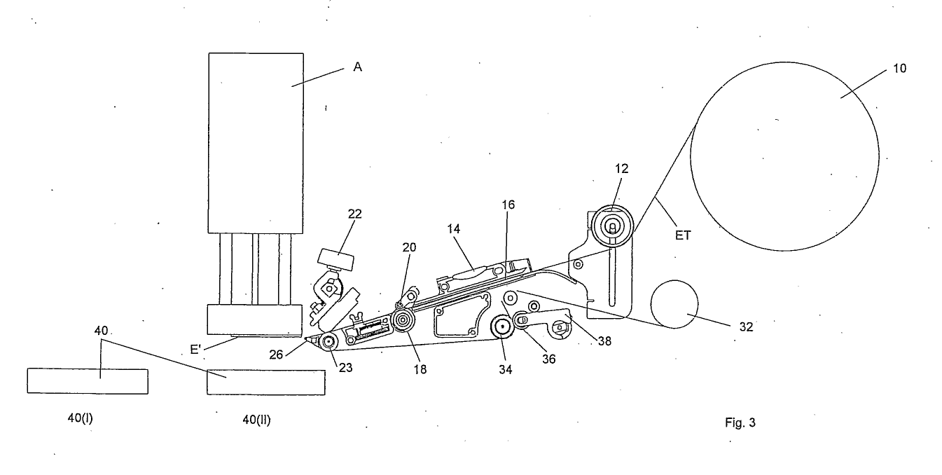

FIG. 3 shows a diagrammatic side view of a second embodiment of a label printer according to the invention at the moment of delivery of a defective label to a collecting unit provided for same,

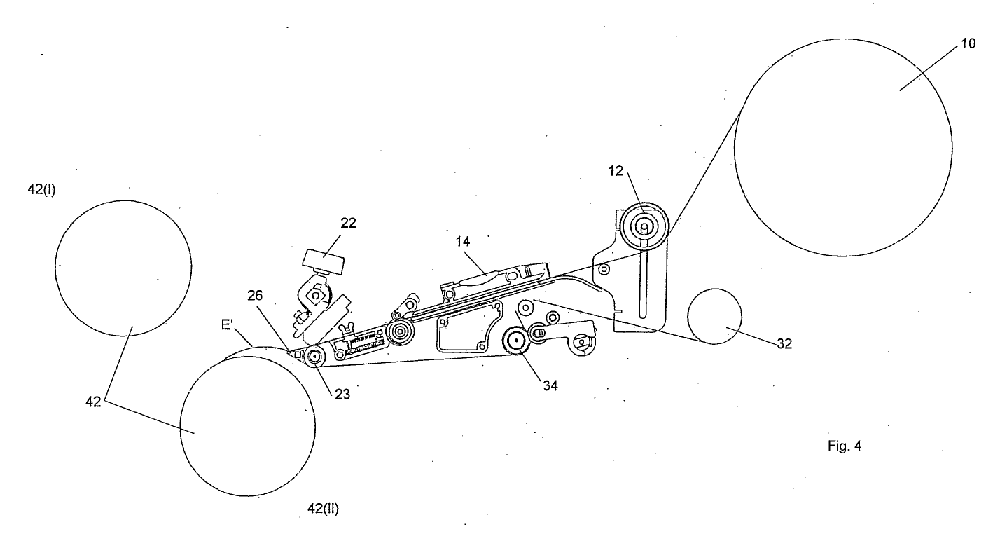

FIG. 4 shows a diagrammatic side view of a third embodiment of a label printer according to the invention at the moment of delivery of a defective label to a collecting unit which is of a different configuration in relation to the collecting unit shown in FIG. 3,

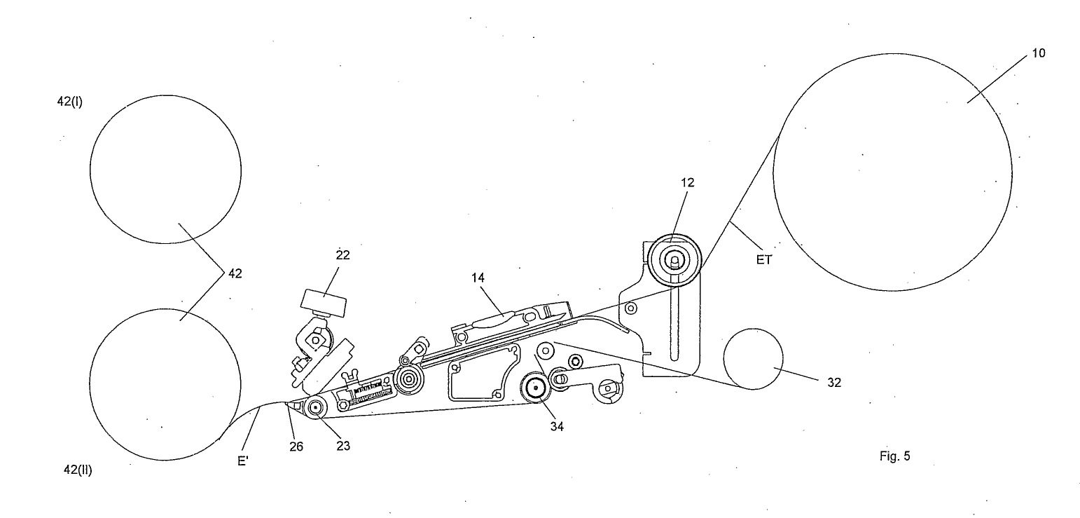

FIG. 5 shows a diagrammatic side view of a fourth embodiment of a label printer according to the invention at the moment of delivery of a defective label to a collecting unit similar to the collecting unit shown in FIG. 4, and

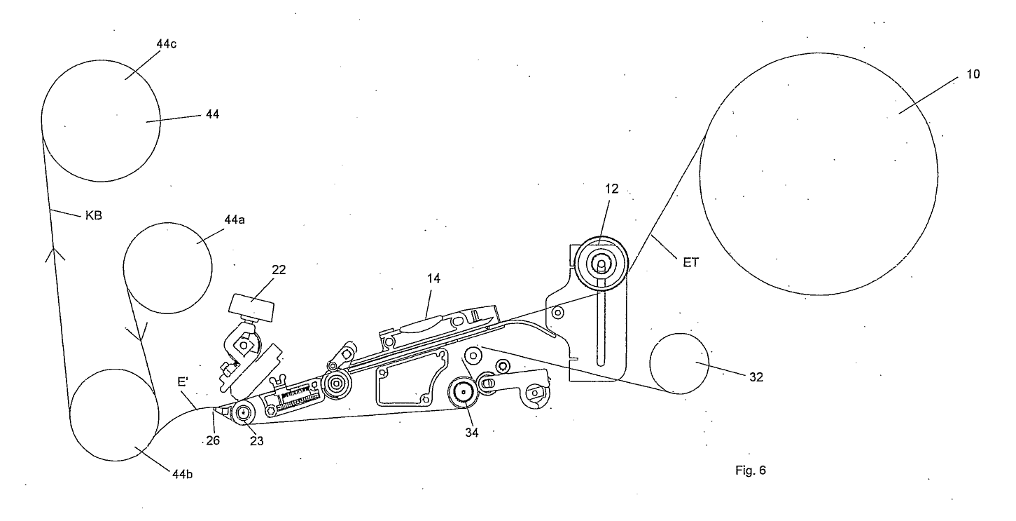

FIG. 6 shows a diagrammatic side view of a fifth embodiment of a label printer according to the invention at the moment of delivery of a defective label to a further embodiment of a collecting unit.

FIGS. 1 and 2 each show a diagrammatic side view of a first embodiment of a label printer according to the invention which is suitable for carrying out the method according to the invention. In this connection it is to be noted that the housing of the label printer is not further illustrated.

The label printer according to the invention, as essential components, has a supply roll 10 which is formed by the wound-up label carrier strip ET and the axis (not shown) of which extends at least approximately horizontally. Disposed on the label carrier strip ET at regular spacings are labels E which have an RFID portion and a printable portion or print carrier portion. Both the RFID portion and also the print carrier portion are not shown in greater detail.

The label carrier strip ET provided with the labels E is drawn off the supply roll 10, guided vertically downwardly and passed around a direction-changing roller 12 whose axis is also oriented at least approximately horizontally. The direction-changing roller 12 directs the label carrier strip ET which is fed at least approximately vertically thereto in a horizontal direction. Provided downstream of the direction-changing roller 12 in the conveyor direction of the label carrier strip ET is an RFID reading and/or writing unit 14. The RFID reading and/or writing unit 14 is formed inter alia by an antenna arranged below the label carrier strip ET which in that region extends horizontally. That RFID reading and/or writing unit 14 at the same time forms a testing unit which tests the RFID portion of a label E which is on the label carrier strip ET for defects. In principle there is the possibility in this respect of the RFID portion of the label E already being provided with items of information which do not have to be supplemented by any further items of information. In such a situation the RFID reading and/or writing unit 14 is only a reading unit. If in contrast items of information are to applied to or introduced into the RFID portion of the label E, then the RFID reading and/or writing unit is an RFID reading and writing unit.

So that the label E which is to be tested and which is arranged on the label carrier strip ET assumes a precisely defined position in relation to the RFID reading and/or writing unit or testing unit 14, provided in the region of the RFID reading and/or writing unit 14 is a tunnel guide 16 which is formed by plate-shaped elements extending at least approximately in parallel relationship with the conveyor path of the label carrier strip ET. In order to permit the label carrier strip ET to be easily threaded into the tunnel guide 16, the tunnel guide 16 has an introduction funnel 16a at its end which faces towards the supply roll 10.

Arranged downstream of the tunnel guide 16 in the conveyor direction of the label carrier strip ET is a first drive roller 18 which is arranged beneath the label carrier strip ET and a counterpressure backing roller 20 provided above the label carrier strip ET.

Both the axis of the drive roller 18 and that of the counterpressure backing roller 20 again extend horizontally. The two rollers 18, 20 receive the label carrier strip ET between them, as is shown in FIGS. 1 and 2, and can convey the label carrier strip ET by the drive for the drive roller 18. In that case the roller 20 provides for adequate contact between the drive roller 18 and the label carrier strip ET so that the conveyor operation can be carried out.

The counterpressure backing roller 20 is mounted to a lever arm 21 which is pivotable in a vertical plane reversibly upwardly and downwardly so that the counterpressure backing roller 20 can compensate for unevenness and irregularities on the label carrier strip ET, as are caused for example by the RFID portion of the label E, without a reduction in the contact pressure of the roller 20, and in that situation damage to the RFID portion is prevented. The first drive roller 18 can be made from steel with a suitable rubber casing. There is also the possibility of the first drive roller 18 being formed from a GRP material with or without a corresponding rubber casing.

Disposed downstream of the drive roller 18 in the conveyor direction of the label carrier strip ET, adjoining the first drive roller 18, is a writing printing unit 22 which is arranged above the label carrier strip ET and which in this application is also referred to as the first writing unit. The second writing unit is formed by the RFID reading and/or writing unit 14.

The writing printing unit 22 is a thermotransfer printing head which can apply items of information to the printable portion or the print carrier portion of the label E by a thermotransfer print operation in known manner. Arranged beneath the writing printing unit 22 is a platen roller 23 which can also be formed from a steel core with a rubber casing or a GRP core with and without a rubber casing.

The writing printing unit 22 can assume the writing position shown in FIGS. 1 and 2. In addition however it can also be lifted off the label carrier strip ET by being pivoted upwardly. That allows the writing printing unit 22 to be protected from damage when the RFID portion of the label E passes through. When the writing printing unit 22 is lifted, it can further be provided that the drive for the platen roller 23 is uncoupled and the roller 23 only idles. When the writing printing unit 22 is applied the platen roller 23 is preferably driven.

Disposed downstream of the writing printing unit 22 in the conveyor direction of the label carrier strip ET is a dispensing unit 24 which, arranged above the label carrier, has a guide roller 25 and a dispensing edge 26. The guide roller 25 whose axis extends at least approximately horizontally is arranged downstream of the writing printing unit 22 or the platen roller 23 in the conveyor direction of the label carrier strip ET, while the dispensing edge 26 directly adjoins the guide roller 25 downstream in the conveyor direction of the label carrier strip ET.

As can further be seen from FIGS. 1 and 2 the label carrier strip ET in the region of the dispensing unit 24 bears against a guide element 28 which has a horizontal portion which faces in the direction of the supply roll 10 and an inclinedly upwardly extending portion which terminates in the dispensing edge 26. The guide roller 25 which can possibly be removed and/or lifted off is so arranged in that case that it is disposed in the transition from the horizontal portion to the inclinedly upwardly extending portion of that guide 28 so that it is in tangential contact with both the horizontally extending portion and also the inclinedly upwardly extending portion.

As can further be seen from FIG. 1 the label carrier strip ET is sharply deflected at the dispensing edge 26 as a consequence of the radius of the dispensing edge 26 being very small there, and is guided downwardly. As a consequence of the sharp deflection of the label carrier strip ET at the dispensing edge 26, a label E which is to be applied or dispensed is lifted off the label carrier strip ET and can then be applied to the article to be identified, by means of an applicator unit A (see FIG. 3). The label carrier strip ET from which the label E has been removed, that is to say the empty label carrier strip ET, is guided to a further deflection edge 30 and from there onto a take-up roll 32 which serves as an empty material storage unit.

The mode of operation of the label printer according to the invention is as follows:

A portion of the label carrier strip ET which has been drawn off the supply roll 10 and to which a label E to be written to is applied is firstly guided after deflection at the direction-changing roller 12 to the testing unit or RFID reading and/or writing unit 14. There, a check is made to ascertain whether the RFID portion of the label E is intact. If that is the case then the label E is fed to the writing printing unit 22 and the desired information printed thereon. Items of information can also possibly be previously read from the RFID portion of the label E in the RFID writing and/or reading unit and/or written into the RFID portion of the label E.

Then the label carrier strip ET together with the label E is fed to the dispensing unit 24, in which case, in order to avoid damage to the RFID portion of the label E, the writing printing unit 22 is lifted, that is to say pivoted away from the label carrier strip ET. Due to the sharp deflection of the label carrier strip ET at the dispensing edge 26, the label E which has been printed and/or written to in the RFID portion is pulled off the label carrier strip ET and can then be engaged by the applicator unit A and applied to the article to be identified by the label E. The label carrier strip ET from which the label E has been removed is deflected at the dispensing edge 26 and fed to the deflection device 30 to the take-up roll 32 for the empty label carrier strip ET, and wound on thereat.

If in comparison the testing unit or RFID reading and/or writing unit 14 establishes that the RFID portion of the label E′ is defective, the label carrier strip ET is further conveyed. However, a writing operation by means of the RFID reading and/or writing unit 14 and/or a writing printing operation by means of the writing printing unit 22 is prevented. Possibly in that case then the writing printing unit 20 can be lifted off the label carrier strip ET. In order now to prevent the label E′ from being dispensed from the label carrier strip ET and in order in that way to be able to wind the defective label E′ together with the label carrier strip ET onto the take-up roll 32, the deflection radius at the dispensing unit 24 or at the dispensing edge 26 is increased. That can be effected on the one hand by different rotary speeds acting between the first drive roller 18 and the take-up roll 32 serving as a second drive roller, in particular by the rotary speed of the take-up roll 32 being less than the rotary speed of the first drive roller 18. Equally there is the possibility of the first drive roller 18 being stopped and the take-up roll 32 being driven in opposite relationship to the normal winding direction so that the loop with an increased deflection radius can be produced at the dispensing edge 26. In that case the guide roller 25 can be lifted in order to promote the formation of the large deflection radius. The label carrier strip ET which is pushed back by the take-up roll 32 can involve an empty portion, that is to say the defective label E′ is still in the region of the testing unit 14 or shortly thereafter upstream of the dispensing edge 26. It is only after the larger deflection radius is afforded that then the defective label E′ is discharged from the printer, that is to say guided past the dispensing edge 26. The functionality whereby the defective label E′, prior to discharge to the collecting unit, that is to say to the take-up roll 32 or to another of the collecting units described hereinafter with reference to FIGS. 3 to 6, is still in the printer, before the enlarged deflection radius is produced or the collecting unit in question has been moved into the receiving position, can be present in all embodiments of the label printer according to the invention.

Alternatively, as a further possible way of producing the increased deflection radius, the take-up roll 32 can be stopped and the first drive roller 18 can be further driven so that the loop with an enlarged deflection radius is also produced at the dispensing edge 26.

It is also to be noted that the above-outlined procedure can also be used if the testing unit 14 is used for checking a pure label to be printed.

FIGS. 3 to 6 show embodiments of a label printer according to the invention. These label printers are in part of a similar structure and are in part operated in a similar manner to the label printer described with reference to FIGS. 1 and 2 so that, in relation to FIGS. 3 to 6, only the differences between those label printers and the label printer described with reference to FIGS. 1 and 2 will be discussed in detail.

The second embodiment of a label printer according to the invention as shown in FIG. 3 differs from the first embodiment described with reference to FIGS. 1 and 2 initially in that the RFID reading and/or writing unit 14 is arranged above the label carrier strip ET in the region of the tunnel guide 16. In addition the label printer shown in FIG. 3 differs from the first embodiment in that the deflection edge 30 is formed by the platen roller 23. In other words the label carrier strip ET is deflected at the dispensing edge 26 and immediately returned to the platen roller 23. From there the empty label carrier strip ET extends almost horizontally to a further direction-changing roller 34 which in addition to or instead of the take-up roll 32 can form the second drive unit of the conveyor unit, and there it is deflected inclinedly towards top left. Disposed at the direction-changing roller 34 on the other side of the label carrier strip ET, that is to say on that side on which the dispensed label E was arranged, there is a counterpressure backing roller 36 which is held rotatably on a possibly pivotable arm 38 and preferably without a drive. That counterpressure backing roller 36 bears against the label carrier strip ET so that it is securely received between the direction-changing roller 34 and the counterpressure backing roller 36 and is guided therethrough. In that case the counterpressure backing roller 36 performs the same function as the counterpressure backing roller 20.

After the pair of rollers 34, 36 the empty label carrier strip ET is passed to a further direction-changing roller 39 at which it is deflected in a direction inclinedly downwardly towards the right to the take-up roll 32. That structure of the guide means for the empty label carrier strip ET from the dispensing edge 26 to the take-up roll 32 affords an advantage in terms of the vertical amount of space required in comparison with the variant shown in FIGS. 1 and 2 as the empty label carrier strip ET is not guided over a long distance inclinedly downwardly to the deflection edge 30, as is shown in FIGS. 1 and 2, but after the dispensing edge 26 is guided in an almost horizontal direction to the take-up roll 32.

Unlike the first embodiment, in the second embodiment of the label printer according to the invention the guide 28 can only be in the form of a continuously straight portion. It is to be noted that both alternatives can be used in all printers according to the invention.

A further difference between the first embodiment of a label printer as shown in FIGS. 1 and 2 and the second embodiment of the label printer as shown in FIG. 3 is that a defective label E′ is engaged at the dispensing edge 26, just like a fault-free label E, by the applicator unit A. The applicator unit A comprises a vertically displaceable applicator head (not identified) which by means for example of a reduced pressure engages a label E on the side in opposite relationship to the adhesive layer on the label E. The applicator device A can then deliver a label E engaged in that way onto an article to be identified. If the label E is a defective label E′, then after being dispensed at the dispensing edge 26, it is also engaged by the applicator unit A but it is not delivered to an article to be identified thereby but to a collecting unit 40 formed by a horizontally displaceable table. The table 40 can reversibly assume two positions, namely a waiting position 40 (I) and a working position 40 (II). In the waiting position 40 (I) the table 40 is disposed to the left beside the applicator unit A. In comparison in the working position 40 (II) the table 40 is arranged beneath the applicator unit A and can receive the defective label E′, more specifically in such a way that the defective label E′ is deposited on the table 40. The label E′ can be sufficiently fixed on the table 40 by the adhesive layer at the underside of the defective label E′. The horizontal displaceability of the table 40 can be afforded for example by electric motor means, hydraulically, pneumatically or in any other suitable fashion. In addition the table 40 can be displaceable not only horizontally but also vertically in order to receive a stack of defective labels E′.

FIG. 4 shows a third embodiment of a label printer according to the invention. This third embodiment differs from the second embodiment only in the configuration of the collecting unit. In this third embodiment of the label printer the collecting unit is formed by a collecting roll 42 which, similarly to the table 40, has a waiting position 42 (I) and a working position 42 (II). In this case the waiting position 42 (I) is disposed inclinedly towards top left above the label E′ or the label carrier strip ET and beside the applicator unit A which is not shown in this Figure. To receive a defective label E′ the collecting roll 42 is moved into the working position 42 (II) where it is disposed just beneath the dispensing edge 26. A defective label E′ can then be dispensed directly from the dispensing edge 26 onto the collecting roll 42, more specifically in the same manner as though a fault-free label E is being delivered onto an article to be identified thereby. After the defective label E′ has been received the collecting roll 42 is moved into the waiting position 42 (I). In that respect displacement of the collecting roll 42 can be effected in the same manner as in the case of the receiving table 40, that is to say by electric motor means, pneumatically, hydraulically or the like. The adhesive coating on the label E′ fixes the defective label E′ on the collecting roll 42. In addition the collecting roll 42 itself can be provided with an adhesive coating. The adhesive coating on the collecting roll 42 can be renewed from time to time, more specifically by an adhesive layer applicator unit (not shown) which applies an adhesive layer to the collecting roll 42 by means of a suitable tool or by means of the collecting roll 42 passing through an adhesive bath.

The fourth embodiment of a label printer according to the invention as shown in FIG. 5 differs from the embodiment of FIG. 4 only insofar as the collecting roll 42 is arranged above the defective label E′ in the working position 42 (II). In other words the defective label E′ is received on its side in opposite relationship to the adhesive layer, at the collecting roll 42. As the defective label E′ does not have an adhesive coating on that side, the collecting roll 42 must usually be provided with an adhesive coating. That can be effected in various ways, for example by the collecting roll 42 being regularly passed through an adhesive bath, or by an adhesive coating being applied to the collecting roll 42, for example in the waiting position 42 (I), by means of suitable tools. It will be appreciated that the collecting roll 42 can also be moved into a further position for application of the adhesive layer.

The fifth embodiment of the label printer according to the invention as shown in FIG. 6 differs from the variants of a label printer as shown in FIGS. 2 to 5 in that the collecting unit is formed by an adhesive strip receiving unit 44. The adhesive strip receiving unit 44 for receiving a defective label E′ comprises a supply roll 44a from which the adhesive strip KB is unwound. The adhesive strip receiving unit 44 also has a direction-changing roller 44b which is reversibly movable from a waiting position (not further shown) into the working position shown in FIG. 6. Finally the adhesive strip receiving unit 44 also has a take-up roll 44c arranged above the feed roll 44a and the direction-changing roller 44b. A defective label E′ is again dispensed at the dispensing edge 26, in which case the direction-changing roller 44b has been previously moved into the working position shown in FIG. 6. The defective label E′ is then dispensed to the adhesive strip KB which is deflected at the direction-changing roller 44b and is then displaced to such an extent that a subsequent defective label E′ can be dispensed onto the adhesive strip KB. If no further defective label E′ then follows, the direction-changing roller 44b is again moved upwardly into the waiting position. If a defective label E′ again occurs in front of the dispensing edge 26, then the direction-changing roller 44b is displaced downwardly into the working position shown in FIG. 6 and the next defective label E′ is delivered to the adhesive strip KB.

It is also to be noted that the rollers and rolls described with reference to FIGS. 3 to 6 can also be made from steel or a suitable GRP material, in each case with or without a rubber casing.

It is further to be noted that the mode of operation of the label printers described with reference to FIGS. 3 to 6 corresponds to that, unless described differently, of the label printer in accordance with the first embodiment.

1. A method of treating defective labels, in particular RFID labels, in a label printer, in which the labels are arranged on a label carrier strip in succession in the conveyor direction of the label carrier strip, which is fed under tensile stress at least to a first writing unit for the selective transfer of items of information onto the labels and then to a dispensing unit in which the labels are individually removed from the label carrier strip and delivered in a dispensing operation onto an article to be provided with a label, wherein after the dispensing operation the empty label carrier strip is received in an empty material storage unit,
characterised in that the label carrier strip with the labels arranged thereon is fed to a testing unit which is arranged upstream of the dispensing unit in the conveyor direction of the label carrier strip and which checks the individual labels for defects, and that in the case of a defective label the dispensing operation for the label onto an article to be provided with a label does not occur.

2. A method according to claim 1 characterised in that the label has at least one printable print carrier portion and an RFID portion, wherein the testing unit checks at least the RFID portion for defects.

3. A method according to claim 2 characterised by an RFID portion with a frequency range of 300 MHz to 3,000 MHz.

4. A method according to claim 1 characterised in that the testing unit is arranged in front of the first writing unit in the conveyor direction of the label carrier strip.

5. A method according to claim 2 characterised in that an RFID reading and/or writing unit is used as the testing unit.

6. A method according to claim 1 characterised in that the label recognised as defective by the testing unit remains on the label carrier strip and is received together with the label carrier strip in the empty material storage unit.

7. A method according to claim 6 in which the dispensing unit has a dispensing edge at which the label carrier strip is deflected through a small radius, the label being detached from the label carrier strip in that case, characterised in that in the case of a defective label the tensile stress in the label carrier strip is so reduced that detachment of the label from the label carrier strip at the dispensing unit does not occur.

8. A method according to claim 7 in which the tensile stress in the label carrier strip is applied to the label carrier strip by means of at least one first drive unit arranged upstream of the dispensing unit in the conveyor direction of the label carrier strip and at least one second drive unit arranged downstream of the dispensing unit, characterised in that the reduction in the tensile stress in the label carrier strip at the dispensing edge is achieved by a difference in the drive power of the first and second drive units.

9. A method according to claim 8 characterised in that at least one drive roller is used as the first and second drive units respectively, the respective rotary speeds of the drive rollers being selected differently to reduce the tensile stress.

10. A method according to claim 9 characterised in that to reduce the tensile stress in the label carrier strip the rotary speed of the second drive roller is selected to be less than the rotary speed of the first drive roller.

11. A method according to claim 9 characterised in that to reduce the tensile stress in the label carrier strip the second drive roller is stopped whereas the first drive roller is further operated.

12. A method according to claim 9 characterised in that to reduce the tensile stress in the label carrier strip the first drive roller is stopped whereas the second drive roller is operated in opposite relationship to the normal rotary conveyor direction.

13. A method according to claim 6 characterised in that the deflection radius of the label carrier strip at the dispensing edge is increased in relation to the radius of the dispensing edge.

14. A method according to claim 13 characterised in that the dispensing unit can be displaced into at least a first working position in which the dispensing operation takes place and a second working position in which the dispensing operation does not occur.

15. A method according to claim 14 characterised in that the dispensing unit is moved into the first or second working position in dependence on the test result of the testing unit.

16. A method according to claim 13 characterised in that to increase the deflection radius the dispensing edge of the dispensing unit is provided with at least one first curved functional surface which serves as a dispensing edge and at least one second curved functional surface, wherein the radius of curvature of the first function surface is selected to be less than the radius of curvature of the second functional surface.

17. A method according to claim 1 characterised in that the defective label is dispensed onto a collecting unit for defective labels, arranged downstream in the conveyor direction of the label carrier strip.

18. A method according to claim 17 characterised in that the collecting unit is reversibly moved, preferably pivoted, into the label dispensing path, to receive a defective label.

19. A method according to claim 17 characterised in that the collecting unit is displaced in a preferably vertical direction to receive a plurality of defective labels.

20. A label printer for printing labels, preferably RFID labels, wherein the label printer is provided in particular for carrying out the method according to claim 1, and includes:
a conveyor unit for conveying under tensile stress a label carrier strip on which the labels are arranged in succession in the conveyor direction of the label carrier strip at least one first writing unit for selectively transferring items of information onto the labels a dispensing unit by means of which the labels are individually removable from the label carrier strip and can be applied in a dispensing operation to an article to be provided with a label and an empty material storage unit for receiving the empty label carrier strip,
characterised in that there is provided a testing unit which is arranged upstream of the dispensing unit in the conveyor direction of the label carrier strip and which checks the individual labels for defects and which actuates the dispensing unit and/or the conveyor unit in accordance with the conveyor result.

21. A label printer according to claim 20 characterised in that the label has at least a printable portion and an RFID portion, wherein the testing unit tests at least the freedom from defect of the RFID portion.

22. A label printer according to claim 20 characterised in that the RFID portion has a frequency range of 300 MHz to 3,000 MHz.

23. A label printer according to claim 20 to characterised in that the testing unit is arranged in front of the first writing unit in the conveyor direction of the label carrier strip.

24. A label printer according to claim 21 characterised in that the testing unit is an RFID reading and/or writing unit.

25. A label printer according to claim 20 characterised in that the label recognised by the testing unit as defective remains on the label carrier strip and is receivable together with the label carrier strip in the empty material storage unit.

26. A label printer according to claim 25 wherein the dispensing unit has a dispensing edge at which the label carrier strip is deflected through a small radius, the label being detached from the label carrier strip in that case, characterised in that in the case of a defective label the tensile stress in the label carrier strip can be reduced by the conveyor unit so that detachment of the label from the label carrier strip at the dispensing unit does not occur.

27. A label printer according to claim 26 wherein the conveyor unit has at least one first drive unit arranged upstream of the dispensing unit in the conveyor direction of the label carrier strip and at least one second drive unit arranged downstream of the dispensing unit characterised in that the first drive unit and the second drive unit are connected to a control unit, by means of which the first and second drive units are actuable with different control values in respect of the drive power.

28. A label printer according to claim 27 characterised in that the first and second drive units are each a respective drive roller whose rotary speed can be selected differently by means of the control unit to reduce the tensile stress.

29. A label printer according to claim 28 characterised in that the rotary speed of the second drive roller is less than the rotary speed of the first drive roller to reduce the tensile stress in the label carrier strip.

30. A label printer according to claim 25 characterised in that the deflection radius of the label carrier strip at the dispensing edge can be increased to suppress the dispensing operation.

31. A label printer according to claim 30 characterised in that to increase the deflection radius of the label carrier strip the dispensing unit is displaceable into at least one first working position in which the dispensing operation can be carried out and into at least one second working position in which the dispensing operation does not occur.

32. A label printer according to claim 31 characterised in that the dispensing unit is movable into the first or the second working position in dependence on the test result of the testing unit.

33. A label printer according to claim 30 to characterised in that to increase the deflection radius of the label carrier strip the dispensing edge of the dispensing unit has at least one first curved functional surface which serves as a dispensing edge and at least one second curved functional surface, wherein the radius of curvature of the first functional surface is less than the radius of curvature of the second functional surface.

34. A label printer according to claim 20 characterised in that the defective label can be dispensed onto a collecting unit for defective labels which is arranged downstream of the dispensing unit in the conveyor direction of the label carrier strip.

35. A label printer according to claim 34 characterised in that the collecting unit is reversibly movable and preferably pivotable into the dispensing path of a label to receive a defective label.

36. A label printer according to claim 34 characterised in that the collecting unit is displaceable in a preferably vertical direction to receive a plurality of defective labels.

37. A label printer according to claim 20 characterised in that at least the conveyor unit and/or the testing unit and/or the dispensing unit are connected to a preferably electronic control unit.
